(19) United States
(12) Patent Application Publication
(10) Pub. No.: US 2018/0272706 A1
(43) Pub. Date: Sep. 27, 2018

(54) LIQUID DISCHARGE HEAD AND LIQUID DISCHARGE APPARATUS

(71) Applicant: TOSHIBA TEC KABUSHIKI KAISHA, Tokyo (JP)

(72) Inventor: Noriyuki Kikuchi, Mishima Shizuoka (JP)

(21) Appl. No.: 15/889,425

(22) Filed: Feb. 6, 2018

(30) Foreign Application Priority Data
Mar. 23, 2017 (JP) 2017-057618

(51) Int. Cl. B41J 2/045

(52) U.S. Cl. CPC B41J 2/04595; B41J 2/04581; B41J 2/04573

(57) ABSTRACT

In accordance with an embodiment, a liquid discharge head comprises a number of times controller and a discharge amount controller. The number of times controller controls the number of times droplets are discharged for one pixel based on input image data. The discharge amount controller controls a discharge amount of the droplet based on the image data.

### CROSS-REFERENCE TO RELATED APPLICATION

This application is based upon and claims the benefit of priority from Japanese Patent Application No. P2017-057618, filed Mar. 23, 2017, the entire contents of which are incorporated herein by reference.

### FIELD

Embodiments described herein relate generally to a liquid discharge head and a liquid discharge apparatus.

### BACKGROUND

There is known an inkjet recording apparatus for recording an image by discharging liquid such as ink from a nozzle as a droplet. In a conventional inkjet recording apparatus, in order to express a plurality of gradations, there is an inkjet recording apparatus capable of discharging droplets plural times for the same pixel. For example, such an inkjet recording apparatus can express gradations of shade by increasing the number of discharge times of the droplet for a pixel to be thickened and decreasing the number of discharge times of the droplet for a pixel to be thinned. Such a system mostly includes gradations from four gradations in which the number of discharge times is 0 to 3 to eight gradations in which the number of discharge times is 0 to 7. However, most of image data of a printing source input to the inkjet recording apparatus are 8 bits for each color. This corresponds to 256 gradations. The number of gradations per pixel recorded by the conventional inkjet recording apparatus is mostly smaller than that of gradations per pixel of the data of the printing source. Therefore, there is a demand to increase the number of gradations that the inkjet recording apparatus can record for the same pixel. Therefore, it is conceivable to increase the maximum number of times the droplets are discharged for the same pixel, i.e., increase the maximum number of times to be more than 7 to increase the number of gradations to be greater than 8. However, if the maximum number of times is increased as described above, there is a problem that the time taken to perform discharge per pixel is increased (drive frequency decreases) as the number of discharge times for one pixel increases.

### DESCRIPTION OF THE DRAWINGS

FIG. 1 is a side schematic view illustrating an example of the constitution of an inkjet recording apparatus according to first to third embodiments;

FIG. 2 is a perspective view illustrating an example of the constitution of a liquid discharge head shown in FIG. 1;

FIG. 3 is an exploded perspective view illustrating an example of the constitution of the liquid discharge head shown in FIG. 1;

FIG. 4 is a block diagram illustrating an example of the circuit constitution of the main portions of the inkjet recording apparatus shown in FIG. 1;

FIG. 5 is a flowchart illustrating a control processing by a processor shown in FIG. 4;

FIG. 6 is a block diagram for explaining input and output of a bit separator, a gradation controller and a volume fine adjustment controller shown in FIG. 4; and

FIG. 7 is a schematic diagram visually illustrating a total discharge amount for each numeric value of gradation data.

### DETAILED DESCRIPTION

In accordance with an embodiment, a liquid discharge head comprises a number of times controller and a discharge amount controller. The number of times controller controls the number of times droplets are discharged for one pixel based on input image data. The discharge amount controller controls a discharge amount of the droplet based on the image data.

Hereinafter, an inkjet recording apparatus according to several embodiments is described with reference to the accompanying drawings. For the sake of explanation, each figure used for the explanation of the embodiments shows the scale of each part by appropriately changing it. For the sake of explanation, each figure used for the description of the embodiments may omit the constitution in some cases.

### First Embodiment

The inkjet recording apparatus according to the first embodiment is described below.

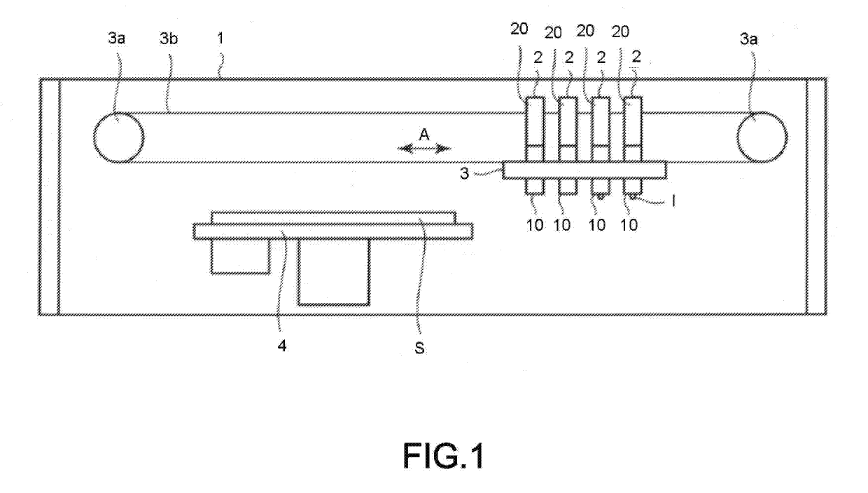

FIG. 1 is a schematic side view illustrating an example of the constitution of an inkjet recording apparatus 1 according to the first embodiment. The inkjet recording apparatus 1 includes a plurality of liquid discharge sections 2, a head support mechanism 3 supporting the liquid discharge section 2 movably, and a medium support mechanism 4 supporting an image receiving medium S movably. The image receiving medium S is, for example, a paper or a sheet made of resin. The inkjet recording apparatus 1 is an example of a liquid discharge apparatus.

As shown in FIG. 1, the plurality of the liquid discharge sections 2 is supported by the head support mechanism 3 in a state of being aligned in a predetermined direction. The head support mechanism 3 is attached to an endless belt 3b hanging on a roller 3a. The inkjet recording apparatus 1 is capable of moving the head support mechanism 3 in a main scanning direction A orthogonal to a conveyance direction of the image receiving medium S by rotating the roller 3a. The liquid discharge section 2 integrally includes an inkjet head 10 and a circulation device 20. The liquid discharge section 2 performs a discharge operation of discharging, for example, ink I as the liquid from the inkjet head 10. As an example, the inkjet recording apparatus 1 performs an ink discharge operation while reciprocating the head support mechanism 3 in the main scanning direction A to form a desired image on the image receiving medium S arranged opposite to the head support mechanism 3. The liquid discharge section 2 is an example of a liquid discharge apparatus.

The plurality of the liquid discharge sections 2 discharges ink of four colors of CMYK, i.e., cyan ink, magenta ink, yellow ink, and black ink, respectively.

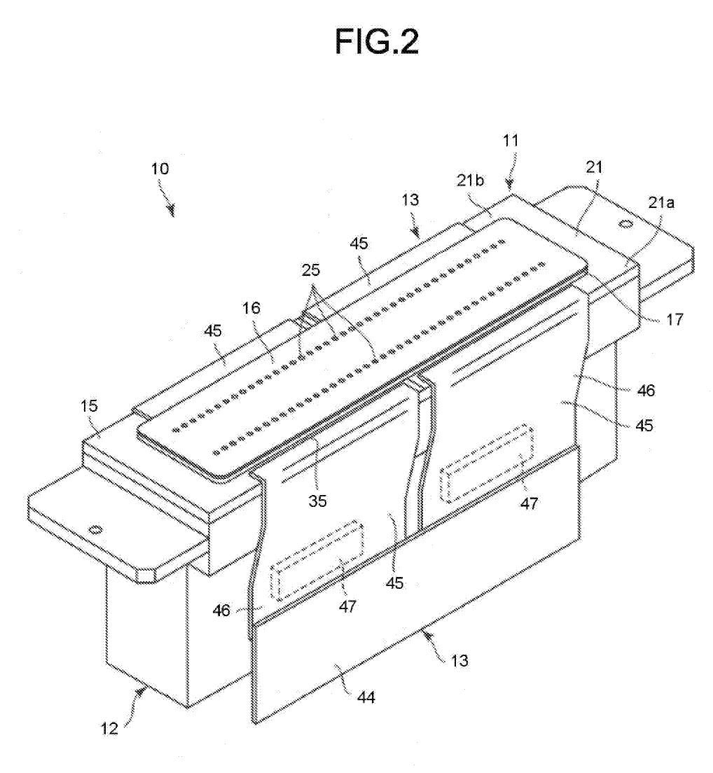

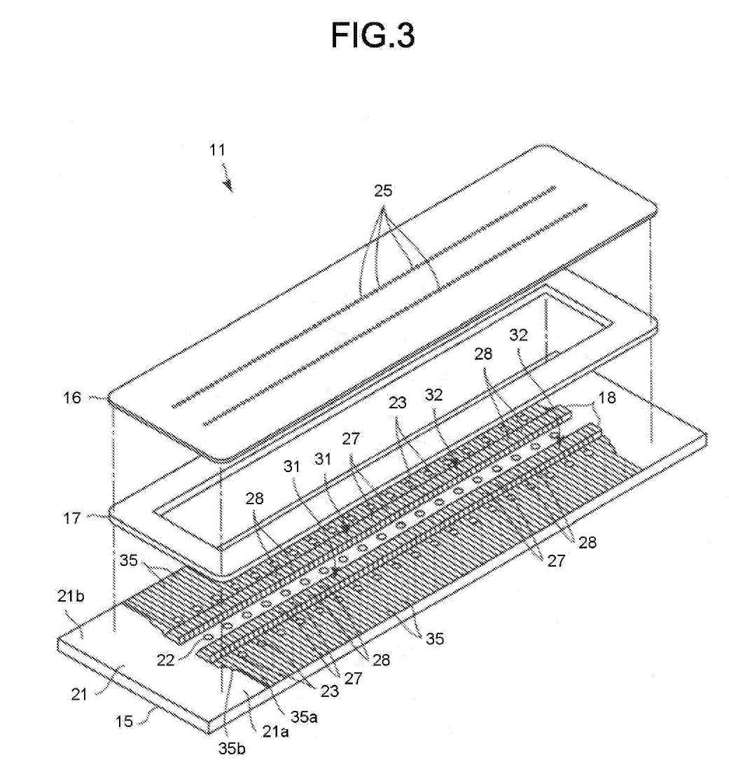

FIG. 2 is a perspective view illustrating an example of the constitution of the inkjet head 10. FIG. 3 is an exploded perspective view illustrating an example of the constitution of the inkjet head 10. Incidentally, in this embodiment, a circulation type inkjet head 10 is exemplified.

As shown in FIG. 2, the inkjet head 10 is a so-called side shooter type inkjet head. The inkjet head 10 is loaded on an inkjet printer, and is connected to an ink tank via components such as a tube. Such an inkjet head 10 includes a head main body 11, a unit section 12, and a pair of circuit boards 13. The inkjet head 10 is an example of a liquid discharge head.

The head main body 11 is used for discharging the ink. The head main body 11 is attached to the unit section 12. The unit section 12 includes a manifold forming a part of a path between the head main body 11 and the ink tank and a member for mounting at the inside of the inkjet printer. The pair of the circuit boards 13 is attached to the head main body 11, respectively.

The head main body 11 includes a base plate 15, a nozzle plate 16, a frame member 17, and a pair of the drive elements 18. At the inside of the head main body 11, an ink chamber to which the ink is supplied is formed.

The base plate 15 is formed into a rectangular plate shape by ceramics such as alumina, for example. The base plate 15 has a flat mounting surface 21. A plurality of supply holes 22 and a plurality of discharge holes 23 are opened in the mounting surface 21.

The supply holes 22 are arranged side by side in a longitudinal direction of the base plate 15 at the center of the base plate 15. The supply hole 22 communicates with an ink supply section of the manifold of the unit section 12. The supply hole 22 is connected to the ink tank in the circulation device 20 via the ink supply section. The ink in the ink tank is supplied to the ink chamber through the ink supply section and the supply hole 22.

The discharge holes 23 are arranged side by side in two rows so as to sandwich the supply hole 22 therebetween. The discharge hole 23 communicates with an ink discharge section of the manifold of the unit section 12. The discharge hole 23 is connected to the ink tank in the circulation device 20 via the ink discharge section. The ink in the ink chamber is collected in the ink tank through the ink discharge section and the discharge hole 23. As a result, the ink circulates between the ink tank and the ink chamber.

The nozzle plate 16 is formed by, for example, a rectangular film made of polyimide imparting a lyophobic function to the surface thereof. The nozzle plate 16 faces the mounting surface 21 of the base plate 15. The nozzle plate 16 is provided with a plurality of nozzles 25. The plurality of nozzles 25 is arranged in two rows along the longitudinal direction of the nozzle plate 16.

The frame member 17 is formed into a rectangular frame shape by, for example, a nickel alloy. The frame member 17 is interposed between the mounting surface 21 of the base plate 15 and the nozzle plate 16. The frame member 17 adheres to the mounting surface 21 and the nozzle plate 16, respectively. The nozzle plate 16 is attached to the base plate 15 via the frame member 17. The ink chamber is formed by being surrounded by the base plate 15, the nozzle plate 16, and the frame member 17.

The drive element 18 is formed by two plate-like piezoelectric bodies formed by lead zirconate titanate (PZT), for example. The two piezoelectric bodies are bonded so that polarization directions thereof are opposite to each other in a thickness direction thereof.

The pair of the drive elements 18 is bonded to the mounting surface 21 of the base plate 15. The pair of the drive elements 18 is arranged in parallel in the ink chamber in correspondence with the nozzles 25 aligned in two rows. The drive element 18 is formed in a trapezoidal cross section. The top of the drive element 18 adheres to the nozzle plate 16.

The drive element 18 is provided with a plurality of grooves 27. The grooves 27 extend in a direction crossing the longitudinal direction of the drive element 18, and are aligned in the longitudinal direction of the drive element 18. The plurality of grooves 27 faces the plurality of nozzles 25 of the nozzle plate 16. The drive element 18 of the present embodiment is provided with a plurality of pressure chambers that are driving flow paths for discharging the ink to the grooves 27.

Electrodes 28 are provided in the plurality of grooves 27, respectively. The electrode 28 is formed, for example, by processing a nickel thin film by photoresist etching. The electrode 28 covers an inner surface of the groove 27.

From the mounting surface 21 of the base plate 15 to the drive element 18, a plurality of wiring patterns 35 is provided. These wiring patterns 35 are formed, for example, by photoresist etching processing a nickel thin film.

The wiring patterns 35 extend from one side end 21a and the other side end 21b of the mounting surface 21, respectively. The side ends 21a and 21b include not only an edge of the mounting surface 21 but also the peripheral region thereof. Therefore, the wiring pattern 35 may be provided inside the edge of the mounting surface 21.

Description of the wiring pattern 35 extending from one side end 21a is described below as a representative. The basic constitution of the wiring pattern 35 at the other side end 21b is the same as the one in the wiring pattern 35 at the one side end 21a.

The wiring pattern 35 has a first portion 35a and a second portion 35b. The first portion 35a of the wiring pattern 35 extends linearly from the side end 21a of the mounting surface 21 toward the drive element 18. The first portions 35a extend in parallel with each other. The second portion 35b of the wiring pattern 35 extends over an end of the first portion 35a and the electrode 28. The second portion 35b is electrically connected to the electrode 28, respectively.

In one drive element 18, several electrodes 28 among the plurality of electrodes 28 constitute a first electrode group 31. The other several electrodes 28 among the plurality of electrodes 28 constitute a second electrode group 32.

The first electrode group 31 and the second electrode group 32 are separated from each other at the center in the longitudinal direction of the drive element 18. The second electrode group 32 is adjacent to the first electrode group 31. The first and second electrode groups 31 and 32 include, for example, 159 electrodes 28, respectively.

As shown in FIG. 2, the pair of the circuit boards 13 has a board main body 44 and a pair of film carrier packages (FCP) 45, respectively. The FCP is also referred to as a tape carrier package (TCP).

The board main body 44 is a print wiring board formed into a rectangular shape and having rigidity. Various electronic components and connectors are mounted on the board main body 44. A pair of FCPs 45 is attached to the board main body 44, respectively.

The pair of FCPs 45 each have a flexible resin film 46 having a plurality of wirings formed thereon and a head drive circuit 47 connected to the plurality of wirings. The film 46 is a tape automated bonding (TAB). The head drive circuit 47 is an IC (Integrated Circuit) for applying a voltage to the electrode 28. The head drive circuit 47 is fixed to the film 46 by resin.

The end of one FCP 45 is bonded to the first portion 35a of the wiring pattern 35 through thermocompression by an anisotropic conductive film (ACF). Thus, the plurality of wirings of the FCP 45 is electrically connected to the wiring pattern 35.

By connecting the FCP 45 to the wiring pattern 35, the head drive circuit 47 is electrically connected to the electrode 28 via the wiring of the FCP 45. The head drive circuit 47 applies a voltage to the electrode 28 via the wiring of the film 46.

If the head drive circuit 47 applies the voltage to the electrode 28, the drive element 18 is deformed in a share mode, thereby increasing or decreasing the volume of the pressure chamber provided with the electrode 28. As a result, the pressure of the ink in the pressure chamber changes, and the ink is discharged from the nozzle 25. In this way, the drive element 18 separating the pressure chambers becomes an actuator for applying a pressure vibration to the inside of the pressure chamber.

The circulation device 20 shown in FIG. 1 is integrally connected to the upper part of the inkjet head 10 by connection components such as metal. The circulation device 20 includes a predetermined circulation path constituted be capable of circulating liquid through the ink tank and the inkjet head 10. The circulation device 20 is provided with a pump for circulating the liquid. The liquid is supplied from the circulation device 20 to the inside of the inkjet head 10 through the ink supply section through the operation of the pump, and then sent from the inside of the inkjet head 10 to the circulation device 20 via the ink discharge section after passing through a predetermined flow path.

Further, the circulation device 20 replenishes the liquid from the cartridge as a replenishing tank provided outside the circulation path to the circulation path.

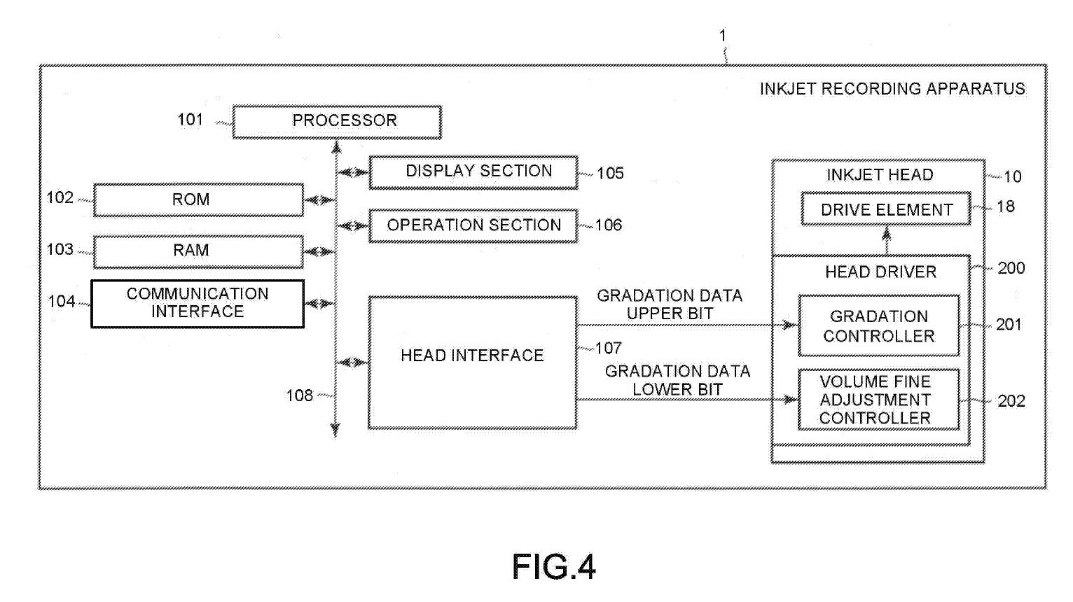

The circuit constitution of the main portions of the inkjet recording apparatus 1 is described. FIG. 4 is a block diagram illustrating an example of the circuit constitution of the main portions of the inkjet recording apparatus 1 according to the embodiment.

The inkjet recording apparatus 1 includes a processor 101, a ROM (read-only memory) 102, a RAM (random-access memory) 103, a communication interface 104, a display section 105, an operation section 106, a head interface 107, a bus line 108 and an inkjet head 10.

The processor 101 acts as a central part of a computer executing processing and control necessary for the operation of the inkjet recording apparatus 1. The processor 101 controls each section to realize various functions of the inkjet recording apparatus 1 based on a program such as an operating system or application software stored in the ROM 102. The processor 101 is, for example, a CPU (central processing unit), a MPU (micro processing unit) or a GPU (graphics processing unit), or a combination thereof.

The ROM 102 acting as a main memory part of the computer with the processor 101 as the central part is a nonvolatile memory which is exclusively used for reading data. The ROM 102 stores an operating system or a program such as application software. Further, the ROM 102 stores data used by the processor 101 to execute various processing, various setting values, or the like.

The RAM 103 is a volatile memory acting as a main memory part of the computer with the processor 101 as the central part. The RAM 103 is used as a so-called work area or the like for storing data temporarily used by the processor 101 to execute various processing. Further, the RAM 103 stores a job list that is a list of unprinted print jobs. The print job includes data such as an image which is a printing object.

The program stored in the ROM 102 includes a control program described with respect to a control processing described later. As an example, the inkjet recording apparatus 1 is transferred to an administrator of the inkjet recording apparatus 1 with the control program stored in the ROM 102. However, the inkjet recording apparatus 1 may be transferred to the administrator in a state in which the control program described with respect to the control processing described later is not stored in the ROM 102. The inkjet recording apparatus 1 may be transferred to the administrator with another control program stored in the ROM 102. Then, the control program described with respect to the control processing described later may be separately transferred to the administrator, and may be written into the ROM 102 under the operation of the administrator or a service person. The transfer of the control program at this time can be realized by being recorded in a removable image receiving medium such as a magnetic disk, a magneto optical disk, an optical disk, a semiconductor memory, or the like, or by being downloaded via a network.

The communication interface 104 is used by the inkjet recording apparatus 1 to perform communication via a network or the like.

The display section 105 displays a screen for notifying an operator of the inkjet recording apparatus 1 of various information. The display section 105 is, for example, a display such as a liquid crystal display or an organic EL (Electro-Luminescence) display.

The operation section 106 receives an operation by an operator of the inkjet recording apparatus 1. The operation section 106 is, for example, a keyboard, a keypad or a touch pad. As the operation section 106, a touch pad overlaid on a display panel of the display section 105 can also be used. In other words, the display panel provided in the touch panel can be used as the display section 105, and the touch pad of the touch panel can be used as the operation section 106.

The head interface 107 is arranged for the processor 101 to communicate with the inkjet head 10. Under the control of the processor 101, the head interface 107 transmits gradation data to the inkjet head 10.

The bus line 108 includes an address bus line, a data bus line, and the like, and transmits a signal transmitted and received by each section of the inkjet recording apparatus 1.

The inkjet head 10 includes a head driver 200.

The head driver 200 is a drive circuit for operating the inkjet head. The head driver is, for example, a line driver. The head driver 200 applies a driving voltage to each of the plurality of the drive elements 18 based on the input gradation data. The head driver 200 includes a gradation controller 201 and a volume fine adjustment controller 202.

The gradation controller 201 controls the number of times the droplet is discharged for the same pixel based on the input gradation data.

The volume fine adjustment controller 202 controls an amount (volume) of the droplet to be discharged based on the input gradation data.

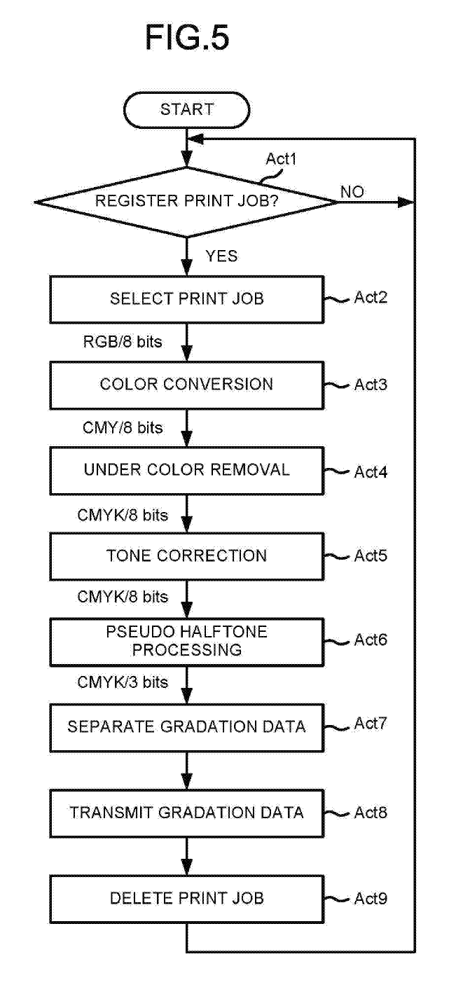

Below, the operation of the inkjet recording apparatus according to the first embodiment is described with reference to FIG. 5. The content of the processing in the following operation description is merely an example, and various processing capable of achieving the same result can be appropriately used. FIG. 5 is a flowchart of the control processing by the processor 101 of the inkjet recording apparatus 1. The processor 101 executes this control processing based on the control program stored in the ROM 102.

In the following operation description, an example of expressing the number of gradations which is more than 4 in which the number of discharge times is 0 to 3 is described.

In Act 1 in FIG. 5, the processor 101 confirms whether or not a print job is registered in the job list. If the print job is not registered in the job list, the processor 101 determines No in Act 1 and repeats the processing in Act 1. Thus, the processor 101 repeats the processing in Act 1 until the print job is registered in the job list. If the print job is registered in the job list, the processor 101 determines Yes in Act 1 and proceeds to the processing in Act 2.

For example, the print job is registered in the job list as follows. The processor 101 waits for until the print job is received by the communication interface 104. Then, if the print job is received, the processor 101 registers the print job in the job list. The processor 101 waits for until an operation for instructing execution of the printing is executed to the operation section 106. If the processor 101 confirms that the operation is performed, the processor 101 registers the content of printing based on the operation in the job list as the print job. The above processing for registering the print job in the job list is executed concurrently or in parallel with the processing shown in FIG. 5 by being executed in a thread different from the processing shown in FIG. 5.

In Act 2, the processor 101 selects a print job to be printed next from the job list. Generally, the processor 101 selects the first registered print job in the job list as the print job to be printed next. The processor 101 proceeds to the processing in Act 3 after the processing in Act 2.

In Act 3, the processor 101 performs color conversion on data which is the printing object included in the print job selected in Act 2. The processor 101 converts bitmap image data in a RGB color mode which is the printing object to image data in a CMY color mode. If the data which is the printing object includes data other than images, the processor 101 performs the color conversion after converting the data to the image data. If the data which is the printing object includes the image data in a color mode other than RGB color mode, the processor 101 converts the image data to the RGB color mode and then performs the above color conversion. If the data which is the printing object includes a vector image, the processor 101 converts vector image data into a bitmap image data and then performs the above color conversion. In the description of the present operation, the bitmap image data in the RGB color mode which is the printing object is, for example, 8 bits for each color. However, the image data handled by the inkjet recording apparatus 1 is not limited to 8 bits. The processor 101 proceeds to the processing in Act 4 after the processing in Act 3.

In Act 4, the processor 101 performs under color removal on the image data in the CMY color mode in which the color conversion is performed in Act 3. The processor 101 converts the image data in the CMY color mode to image data in a CMYK color mode by separating a gray component of the image data in the CMY color mode and replacing it with a black component, for example. The processor 101 proceeds to the processing in Act 5 after the processing in Act 4.

In Act 5, the processor 101 performs tone correction on the image data in the CMYK color mode in which under color removal is performed in Act 4. The processor 101 adjusts a contrast, a gamma value, a color tone, or the like for the image data, for example. The processor 101 proceeds to the processing in Act 6 after the processing in Act 5.

In Act 6, the processor 101 performs pseudo halftone processing in order to reduce the image data in the CMYK color mode in which the tone correction is performed in Act 5 to 3 bits if the gradation is larger than 3 bits for each color. The processor 101 sets the image data to 3 bits by using, for example, a dither method or an error diffusion method. As a result, the image data having the gradation such as 8 bits which is greater than 3 bits becomes a 3-bit image. The image data is the gradation data of each color, and is a bit string formed by aligning numeric values of 3 bits. The processor 101 proceeds to the processing in Act 7 after the processing in Act 6.

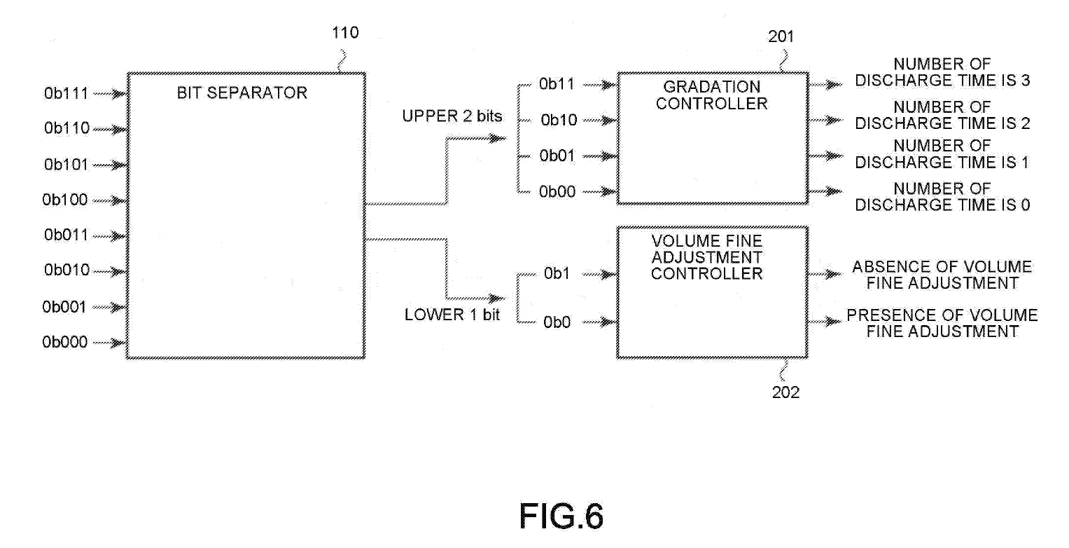

In Act 7, as shown in FIG. 6, the processor 101 functions as a bit separator to separate the 3-bit gradation data into upper 2 bits and lower 1 bit for each pixel. FIG. 6 is a block diagram for explaining input and output of a bit separator 110, the gradation controller 201 and the volume fine adjustment controller 202. For example, 0b110, which is a numeric value of 3 bits, is separated into 0b11 as the upper 2 bits and 0b0 as the lower 1 bit by the bit separator 110. The prefix 0b indicates in the present specification that the numeric value following 0b is a binary number. The bit string in which the upper bits are aligned is an example of first data. Further, a bit string in which the lower bits are aligned is an example of second data. Therefore, the bit separator 110 operates as a separation section that separates the gradation data into the first data input to a number of times control module and the second data input to a discharge amount control module.

The processor 101 instructs the head interface 107 to transmit the gradation data separated into the upper bit and the lower bit in Act 7 to the inkjet head 10 by each color. If the instruction is received, the head interface 107 transmits the gradation data of cyan (C) to the inkjet head 10 using cyan ink. The head interface 107 transmits the gradation data of magenta (M) to the inkjet head 10 using magenta ink. The head interface 107 transmits the gradation data of yellow (Y) to the inkjet head 10 using yellow ink. The head interface 107 transmits the gradation data of black (K) to the inkjet head 10 using black ink. Each of the transmitted gradation data is received by the head driver 200 of each inkjet head 10. At this time, the upper bit of the gradation data is input to the gradation controller 201 and the lower bit of the gradation data is input to the volume fine adjustment controller 202. The processor 101 proceeds to the processing in Act 9 after the processing in Act 8.

In Act 9, the processor 101 deletes the print job selected in Act 2 from the job list. The processor 101 returns to the processing in Act 1 after the processing in Act 9.

Next, the operation of the inkjet head 10 receiving the gradation data is described. In the following description, only one specific color, in other words, a specific inkjet head 10 is described. Actually, the same operation is performed by each inkjet head 10 for each color.

As shown in FIG. 6, the gradation controller 201 to which the upper 2 bits of the gradation data are input controls the discharge of the droplet for the same pixel three times if the upper 2 bits are 0b11, twice if the upper 2 bits are 0b10, once if the upper 2 bits are 0b01, and zero times if the upper 2 bits are 0b00.

As shown in FIG. 6, the volume fine adjustment controller 202 to which the lower 1 bit of the gradation data is input performs control such that the adjustment (hereinafter, referred to as “volume fine adjustment”) of the amount of the discharged droplets is not executed if the 1 bit is 0b1, and the volume fine adjustment is executed if the 1 bit is 0b0. The volume fine adjustment controller 202 sets the one-time discharge amount of any one of the droplets discharged for the same pixel to about half (about 0.5 times) of the normal discharge amount as the volume fine adjustment. Hereinafter, setting the discharge amount of any one of the droplets discharged for the same pixel to approximately n times thereof is referred to as “volume fine adjustment of n”. The normal one-time discharge amount is referred to as Drop. Therefore, in a case of performing volume fine adjustment of n, the one-time discharge amount of any one of the droplets discharged for the same pixel is n Drops. In the case of performing the volume fine adjustment of 0.5, the one-time discharge amount of any one of the droplets discharged for the same pixel is 0.5 Drops.

For the volume fine adjustment, the head driver 200 can perform two kinds of control in the case of (A) below and the case of (B) below, for example.

(A)

In the case of (A), if the discharge amount is changed, the droplets are discharged at the changed discharge amount until the discharge amount is changed next. Normally, in a case of performing the volume fine adjustment of 0.5, the head driver 200 changes the discharge amount to 0.5 Drops for any one of the droplets discharged once for the same pixel and then discharges the droplets. However, the head driver 200 does not need to newly change the discharge amount if the discharge amount at the last discharge is 0.5 Drops. Therefore, in this case, the head driver 200 may discharge droplets without changing the discharge amount. If the discharge amount of the droplet to be discharged next after discharge at the discharge amount of 0.5 Drops is 1 Drop, the head driver 200 discharges the droplets after changing the discharge amount to 1 Drop.

(B)

In the case of (B), the change of the discharge amount is applied only once for the next discharge. In a case of performing the volume fine adjustment of 0.5, the head driver 200 changes the discharge amount to 0.5 Drops for any one of the droplets discharged once for the same pixel, and then discharges the droplets. If the discharge amount of the droplets to be discharged next after the discharge at the discharge amount of 0.5 Drops is 1 Drop, the head driver 200 discharges the droplets without changing the discharge amount.

In a case in which the volume fine adjustment is not performed, the head driver 200 may perform control to perform volume fine adjustment of 1 instead of doing nothing.

The discharge which is the object of the volume fine adjustment is, for example, set as the first discharge for the same pixel, i.e., the first discharge in spite of the number of discharge times. Alternatively, the discharge which is the object of the volume fine adjustment is, for example, the last discharge for the same pixel, i.e., the third discharge if the number of discharge times is 3, the second discharge if the number of discharge times is 2, and the first discharge if the number of discharge times is 1. Alternatively, the discharge which is the object of the volume fine adjustment may be determined by other rules.

From the above, a total discharge amount (Drop number) for one pixel for each numeric value of the gradation data is as shown in Table 1 below.

TABLE 1
TOTAL DISCHARGE AMOUNT FOR EACH NUMERIC VALUE
OF GRADATION DATA (1)

| | GRADATION DATA | | |
|---|---|---|---|
| | AFTER SEPARATION | | |
| GRADATION | | VOLUME | |
| DATA | | FINE | TOTAL |
| BEFORE | GRADATION | ADJUSTMENT | DISCHARGE |
| SEPARATION | CONTROLLER | SECTION | AMOUNT (Drop |
| (3 bits) | (UPPER 2 bits) | (LOWER 1 bit) | NUMBER) |
| 0b111 | 0b11 | 0b1 | 3 |
| 0b110 | | 0b0 | 2.5 |
| 0b101 | 0b10 | 0b1 | 2 |
| 0b100 | | 0b0 | 1.5 |
| 0b011 | 0b01 | 0b1 | 1 |
| 0b010 | | 0b0 | 0.5 |
| 0b001 | 0b00 | 0b1 | 0 |
| 0b000 | | 0b0 | 0 |

In other words, if the gradation data before separation is 0b111, it is divided into the upper 2 bits 0b11 and the lower 1 bit 0b1. Therefore, the number of discharge times is 3, and the volume fine adjustment is not performed. As a result, the Drop number is three.

If the gradation data before separation is 0b110, it is divided into the upper 2 bits 0b11 and the lower 1 bit 0b0. Therefore, the number of discharge times is 3, and the volume fine adjustment of 0.5 is performed. As a result, the Drop number is 2.5.

If the gradation data before separation is 0b101, it is divided into the upper 2 bits 0b10 and the lower 1 bit 0b1. Therefore, the number of discharge times is 2, and the volume fine adjustment is not performed. As a result, the Drop number is 2.

If the gradation data before separation is 0b100, it is divided into the upper 2 bits 0b10 and the lower 1 bit 0b0. Therefore, the number of discharge times is 2, and the volume fine adjustment of 0.5 is performed. As a result, the Drop number is 1.5.

If the gradation data before separation is 0b011, it is divided into the upper 2 bits 0b01 and the lower 1 bit 0b1. Therefore, the number of discharge times is 1, and the volume fine adjustment is not performed. As a result, the Drop number is 1.

If the gradation data before separation is 0b010, it is divided into the upper 2 bits 0b01 and the lower 1 bit 0b0. Therefore, the number of discharge times is 1, and the volume fine adjustment of 0.5 is performed. As a result, the Drop number is 0.5.

If the gradation data before separation is 0b001, it is divided into the upper 2 bits 0b00 and the lower 1 bit 0b1. Therefore, the number of discharge times is 0. As a result, the Drop number is 0.

If the gradation data before separation is 0b000, it is divided into the upper 2 bits 0b00 and the lower 1 bit 0b0. Therefore, the number of discharge times is 0. The volume fine adjustment is not performed because the number of discharge times is 0. As a result, the Drop number is 0.

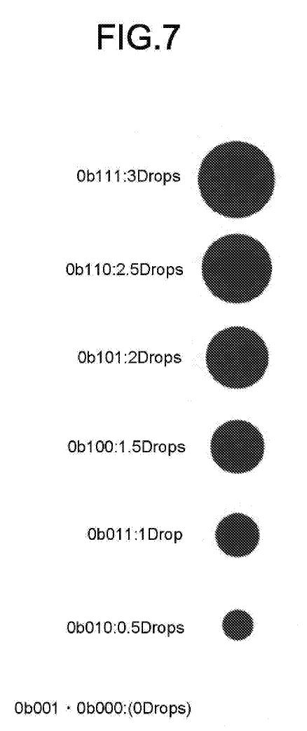

Also, as shown in FIG. 7, the total discharge amount for each numeric value of the gradation data can be visually shown.

The above-described control is performed for each of the plurality of nozzles 25. Further, by repeating the same control based on the gradation data, an image is formed on the image receiving medium S.

Through the above, the gradation controller 201 operates as the number of times controller controlling the number of times of discharging droplets for one pixel based on the gradation data indicating a desired gradation. Then, based on the gradation data, the volume fine adjustment controller 202 operates as the discharge amount controller controlling the amount of each droplet discharged for one pixel. Alternatively, the head driver 200 operates as the number of times controller and the discharge amount controller.

According to the inkjet recording apparatus 1 of the first embodiment, if the lower 1 bit of the gradation data of 3 bits is 0b0, the volume fine adjustment of 0.5 is performed. As a result, the inkjet recording apparatus 1 can express 7 gradations including 0 Drops, 0.5 Drops, 1 Drop, 1.5 Drops, 2 Drops, 2.5 Drops and 3 Drops while the maximum number of discharge times is 3. In a case in which the maximum number of discharge times is 3, conventionally, only four gradations (=2 bits) including 0 Drops, 1 Drop, 2 Drops and 3 Drops can be expressed. On the other hand, the inkjet recording apparatus 1 of the first embodiment can express 7 gradations (≈3 bits) which is larger than the conventional one as described above.

Further, according to the inkjet recording apparatus 1 of the first embodiment, since the number of gradations can be increased compared with the conventional case, without changing the number of discharge times, it is possible to suppress the decrease in the drive frequency compared with a case in which the number of gradations is increased by changing the number of discharge times.

According to the inkjet recording apparatus 1 of the first embodiment, the gradation data is divided into the upper bit and the lower bit. Then, the inkjet recording apparatus 1 inputs the upper bit of the gradation data to the gradation controller 201 and the lower bit of the gradation data to the volume fine adjustment controller 202, respectively. By doing this, the same control as that conventionally executed, i.e., the control of the number of discharge times is performed in the gradation controller 201. Therefore, for the gradation controller 201, the same constitution as the conventional case can be diverted.

According to the inkjet recording apparatus 1 of the first embodiment, the upper bit of the gradation data is the image data representing the 2-bit gradation. Then, the lower bit of the gradation data is the data set to 3-bit gradation by subdividing the gradation of the upper bit. Therefore, the data input to the gradation controller 201 can use the same format as before.

### Second Embodiment

Below, the inkjet recording apparatus according to the second embodiment is described.

Since the inkjet recording apparatus 1 according to the second embodiment has the same constitution as the inkjet recording apparatus 1 according to the first embodiment, a description of its constitution is omitted.

The inkjet recording apparatus 1 according to the second embodiment performs the control processing shown in FIG. 5 in the same manner as the inkjet recording apparatus 1 according to the first embodiment. Therefore, description of the operation is omitted.

The operation of the inkjet head 10 receiving the gradation data of the inkjet recording apparatus 1 according to the second embodiment is described.

In the second embodiment, the head driver 200 controls the number of discharge times and the discharge amount if a combination of the upper bit of the gradation data and the lower bit of the gradation data satisfies a predetermined condition. As an example, the head driver 200 performs control so as to perform volume fine adjustment of 0.75 if the upper 2 bits are 0b01 and the lower 1 bit is 0b0. Then, in a case in which the upper 2 bits are 0b00 and the lower 1 bit is 0b1, the head driver 200 performs control so that the number of discharge times is 1, and the volume fine adjustment of 0.5 is performed.

The total discharge amount (Drop number) for one pixel for each numeric value of the gradation data in the second embodiment is as shown in Table 2 below.

TABLE 2
TOTAL DISCHARGE AMOUNT FOR EACH NUMERIC VALUE
OF GRADATION DATA (2)

| | GRADATION DATA | | |
|---|---|---|---|
| | AFTER SEPARATION | | |
| GRADATION | | VOLUME | |
| DATA | | FINE | TOTAL |
| BEFORE | GRADATION | ADJUSTMENT | DISCHARGE |
| SEPARATION | CONTROLLER | SECTION | AMOUNT (Drop |
| (3 bits) | (UPPER 2 bits) | (LOWER 1 bit) | NUMBER) |
| 0b111 | 0b11 | 0b1 | 3 |
| 0b110 | | 0b0 | 2.5 |
| 0b101 | 0b10 | 0b1 | 2 |
| 0b100 | | 0b0 | 1.5 |
| 0b011 | 0b01 | 0b1 | 1 |
| 0b010 | | 0b0 | 0.75 |
| 0b001 | 0b00 | 0b1 | 0.5 |
| 0b000 | | 0b0 | 0 |

In other words, a case in which the gradation data before separation is 0b000 and 0b011 to 0b111 is the same as that in Table 1 of the first embodiment.

Then, if the gradation data before separation is 0b010, it is divided into the upper 2 bits 0b01 and the lower 1 bit 0b0. In this case, the number of discharge times is 1, and the volume fine adjustment of 0.75 is performed. As a result, the Drop number is 0.75.

If the gradation data before separation is 0b001, it is divided into the upper 2 bits 0b00 and the lower 1 bit 0b1. In this case, the number of discharge times is 1, and the volume fine adjustment of 0.5 is performed. As a result, the Drop number is 0.5.

According to the inkjet recording apparatus 1 of the second embodiment, if the gradation data is 0b010 and 0b001, the head driver 200 controls the number of discharge times and the volume fine adjustment. As a result, the inkjet recording apparatus 1 can express 8 gradations including 0 Drops, 0.5 Drops, 0.75 Drops, 1 Drop, 1.5 Drops, 2 Drops, 2.5 Drops, and 3 Drops while the maximum number of discharge times is 3.

In order to express all 3-bit gradations, it is necessary to express 8 gradations. In the second embodiment, the inkjet recording apparatus 1 can express 8 gradations for one pixel as described above. In other words, the inkjet recording apparatus 1 of the second embodiment can express more gradations than that of the first embodiment, and it is possible to express all 3-bit gradations.

### Third Embodiment

Below, the inkjet recording apparatus according to the third embodiment is described.

Since the inkjet recording apparatus 1 according to the third embodiment has the same constitution as the inkjet recording apparatus 1 according to the first embodiment, a description of its constitution is omitted.

The inkjet recording apparatus 1 according to the third embodiment performs the control processing shown in FIG. 5 in the same manner as the inkjet recording apparatus 1 according to the first embodiment. Therefore, description of the operation is omitted.

The operation of the inkjet head 10 receiving the gradation data of the inkjet recording apparatus 1 according to the third embodiment is described.

In the third embodiment, the head driver 200 controls the number of discharge times and the discharge amount according to the combination of the upper bit of the gradation data and the lower bit of the gradation data.

In the third embodiment, as an example, the head driver 200 performs control so that the total discharge amount (Drop number) for one pixel for each numeric value of the gradation data becomes the total discharge amount as shown in Table 3.

TABLE 3
TOTAL DISCHARGE AMOUNT FOR EACH NUMERIC VALUE
OF GRADATION DATA (3)

| | GRADATION DATA | | |
|---|---|---|---|
| | AFTER SEPARATION | | |
| GRADATION | | VOLUME | |
| DATA | | FINE | TOTAL |
| BEFORE | GRADATION | ADJUSTMENT | DISCHARGE |
| SEPARATION | CONTROLLER | SECTION | AMOUNT (Drop |
| (3 bits) | (UPPER 2 bits) | (LOWER 1 bit) | NUMBER) |
| 0b111 | 0b11 | 0b1 | 3 |
| 0b110 | | 0b0 | 2.75 |
| 0b101 | 0b10 | 0b1 | 2.5 |
| 0b100 | | 0b0 | 2 |
| 0b011 | 0b01 | 0b1 | 1.5 |
| 0b010 | | 0b0 | 1 |
| 0b001 | 0b00 | 0b1 | 0.5 |
| 0b000 | | 0b0 | 0 |

In other words, if the gradation data before separation is 0b111, it is divided into the upper 2 bits 0b11 and the lower 1 bit 0b1. In this case, the number of discharge times is 3, and the volume fine adjustment is not performed. As a result, the Drop number is 3.

If the gradation data before separation is 0b110, it is divided into the upper 2 bits 0b11 and lower 1 bit 0b0. In this case, the number of discharge times is 3, and the volume fine adjustment of 0.75 is performed. As a result, the Drop number is 2.75.

If the gradation data before separation is 0b101, it is divided into the upper 2 bits 0b10 and the lower 1 bit 0b1. In this case, the number of discharge times is 3, and the volume fine adjustment of 0.5 is performed once. Alternatively, the number of the discharge times is 3 and the volume fine adjustment of 0.75 is performed twice. As a result, the Drop number is 2.5.

If the gradation data before separation is 0b100, it is divided into the upper 2 bits 0b10 and the lower 1 bit 0b0. In this case, the number of discharge times is 2, and the volume fine adjustment is not performed. As a result, the Drop number is 2.

If the gradation data before separation is 0b011, it is divided into the upper 2 bits 0b01 and the lower 1 bit 0b1. In this case, the number of discharge times is 2, and the volume fine adjustment of 0.5 is performed once. Alternatively, the number of discharge times is 2, and the volume fine adjustment of 0.75 is performed twice. As a result, the Drop number is 1.5.

If the gradation data before separation is 0b010, it is divided into the upper 2 bits 0b01 and lower 1 bit 0b0. In this case, the number of discharge times is 1, and the volume fine adjustment is not performed. Alternatively, the number of discharge times is 2, and the volume fine adjustment of 0.5 is performed twice. As a result, the Drop number is 1.

If the gradation data before separation is 0b001, it is divided into the upper 2 bits 0b00 and the lower 1 bit 0b1. In this case, the number of discharge times is 1, and the volume fine adjustment of 0.5 is performed once. As a result, the Drop number is 0.5.

If the gradation data before separation is 0b000, it is divided into the upper 2 bits 0b00 and the lower 1 bit 0b0. In this case, the number of discharge times is 0. As a result, the Drop number is 0.

As described above, in the inkjet recording apparatus 1 of the third embodiment, it is possible to freely set the number of discharge times, the number of times of the volume fine adjustment, and how much the volume fine adjustment is performed for each numeric value of the gradation data.

Further, depending on the setting, the number of discharge times, the number of times of the volume fine adjustment, and how much the volume fine adjustment is performed, the total discharge amount difference in one gradation difference can be made approximately equal as shown in Table 4.

TABLE 4
TOTAL DISCHARGE AMOUNT FOR EACH NUMERIC VALUE
OF GRADATION DATA (4)

| | GRADATION DATA | | |
|---|---|---|---|
| | AFTER SEPARATION | | |
| GRADATION | | VOLUME | |
| DATA | | FINE | TOTAL |
| BEFORE | GRADATION | ADJUSTMENT | DISCHARGE |
| SEPARATION | CONTROLLER | SECTION | AMOUNT (Drop |
| (3 bits) | (UPPER 2 bits) | (LOWER 1 bit) | NUMBER) |
| 0b111 | 0b11 | 0b1 | 3.00 |
| 0b110 | | 0b0 | 2.57 |
| 0b101 | 0b10 | 0b1 | 2.14 |
| 0b100 | | 0b0 | 1.71 |
| 0b011 | 0b01 | 0b1 | 1.29 |
| 0b010 | | 0b0 | 0.86 |
| 0b001 | 0b00 | 0b1 | 0.43 |
| 0b000 | | 0b0 | 0 |

In other words, if the gradation data before separation is 0b111, the number of discharge times is 3, and the volume fine adjustment is not performed. As a result, the Drop number is 3.

Then, if the gradation data before separation is 0b110, for example, the number of discharge times is 3, and the volume fine adjustment of 0.57 is performed once. Alternatively, for example, the number of discharge times is 3, and the volume fine adjustment of 0.857 is performed three times. As a result, the Drop number is 2.57.

In a case in which the gradation data before separation is 0b101, for example, the number of discharge times is 3, and the volume fine adjustment of 0.14 is performed once. Alternatively, for example, the number of discharge times is 3, and the volume fine adjustment of 0.714 is performed three times. As a result, the Drop number is 2.14.

If the gradation data before separation is 0b100, for example, the number of discharge times is 2, and the volume fine adjustment of 0.71 is performed once. Alternatively, for example, the number of discharge times is 3, and the volume fine adjustment of 0.57 is performed three times. As a result, the Drop number is 1.71.

If the gradation data before separation is 0b011, for example, the number of discharge times is 2, and the volume fine adjustment of 0.29 is performed once. Alternatively, for example, the number of discharge times is 3, and the volume fine adjustment of 0.43 is performed three times. As a result, the Drop number is 1.29.

If the gradation data before separation is 0b010, for example, the number of discharge times is 1, and the volume fine adjustment is not performed. Alternatively, for example, the number of discharge times is 3, and the volume fine adjustment of 0.286 is performed three times. As a result, the Drop number is 0.86.

If the gradation data before separation is 0b001, for example, the number of discharge times is 1, and the volume fine adjustment of 0.43 is performed once. Alternatively, for example, the number of discharge times is 3, and the volume fine adjustment of 0.143 is performed three times. As a result, the Drop number is 0.43.

If the gradation data before separation is 0b000, the number of discharge times is 0. As a result, the Drop number is 0.

The first to third embodiments can also be modified as follows.

The gradation data is not limited to 3 bits. By using the gradation data of 4 bits or more, the inkjet recording apparatus 1 can handle more gradations than 8 gradations. The upper bit is not limited to 2 bits. For example, if the upper bit is 3 bits, the maximum number of discharge times is 7, and if the upper bit is 4 bits, the maximum number of discharge number can be set to 15. Further, the lower bit is not limited to 1 bit. For example, by setting the lower bit to 2 bits, the volume fine adjustment is not performed if the 2 bits are 0b11, the volume fine adjustment of 0.75 is performed in the case of 0b10, the volume fine adjustment of 0.5 is performed in the case of 0b01, and the volume fine adjustment of 0.25 is performed in the case of 0b00. By doing this, it is possible to further increase the number of gradations without changing the number of discharge times.

In the second embodiment, in a case in which the gradation data is 0b010, the head driver 200 may perform control the same as the first embodiment, and in a case in which the gradation data is 0b001, the head driver 200 may perform control so as to set the number of discharge times as 1, and perform the volume fine adjustment of 0.25. In this case, the inkjet recording apparatus 1 can express 8 gradations including 0 Drops, 0.25 Drops, 0.5 Drops, 1 Drop, 1.5 Drops, 2 Drops, 2.5 Drops and 3 Drops while the maximum number of discharge times is 3.

In the descriptions of the first embodiment to the third embodiment, only the volume fine adjustment less than 1 is shown. However, the inkjet recording apparatus 1 can perform the volume fine adjustment greater than 1. In other words, the inkjet recording apparatus 1 may increase the one-time discharge amount of any one of the droplets discharged for the same pixel as the volume fine adjustment compared with the normal case. By doing this, the degree of freedom of setting the total discharge amount increases.

In the first to third embodiments, if the gradation data before separation is 3 bits, the maximum number of discharge times is 3. If it is assumed that the gradation data before separation is k bits, the maximum number of discharge times is (2k−1−1). However, the maximum number of discharge times may be more than (2k−1−1). By doing this, the degree of freedom of setting the total discharge amount increases. Even in this case, if the maximum number of discharge times is less than (2k−1), it is possible to suppress the decrease in the drive frequency as compared with a case in which only the number of discharge times is changed to increase the gradation.

By increasing the maximum number of discharge times by one, it is possible to express 8 gradations in increments of 0.5 Drops from 0 Drops to 3.5 Drops, for example.

The inkjet recording apparatus 1 may transmit the gradation data to the inkjet head without dividing the gradation data into the upper bit and the lower bit. Then, for example, after the head driver 200 divides the gradation data into the upper bit and the lower bit, the upper bit of the gradation data is input to the gradation controller 201 and the lower bit of the gradation data is input to the volume fine adjustment controller 202.

The head driver 200 may handle the gradation data in a state in which it is not separated into upper bit and the lower bit and perform control based on the gradation data.

In the first to third embodiments, the processor 101 functions as the bit separator 110. However, the bit separator 110 may be implemented by a circuit or the like.

The inkjet recording apparatus (liquid discharge apparatus) 1 in the first embodiment to the third embodiment is an inkjet printer which forms a two-dimensional image by ink on the image receiving medium S. However, the liquid discharge apparatus is not limited to this. The liquid discharge apparatus may be, for example, a 3D printer, an industrial manufacturing machine or a medical machine. If the liquid discharge apparatus is the 3D printer, the liquid discharge apparatus forms a three-dimensional object, for example, by discharging a binder for solidifying the substance or material as a material from the inkjet head. In a case in which the liquid discharge apparatus is the 3D printer, the print job includes three-dimensional image data.

In the first to third embodiments, the upper bit of the gradation data is input to the gradation controller 201 and the lower bit of the gradation data is input to the volume fine adjustment controller 202. However, in a case in which the bits of the gradation data are inverted forth and back, the lower bit of the gradation data may be input to the gradation controller 201 and the upper bit of the gradation data may be input to the volume fine adjustment controller 202.

The inkjet recording apparatus 1 of the embodiment has four liquid discharge sections 2, and the colors of the ink I used by each of the liquid discharge sections 2 are cyan, magenta, yellow or black. However, the number of the liquid discharge sections 2 of the inkjet recording apparatus is not limited to four, and may be one instead of plural liquid discharge sections 2. The colors and characteristics of the ink I used by each of the liquid discharge sections 2 are not limited. In the above embodiment, the inkjet recording apparatus 1 converts the image data of the RGB color mode to the image data of the CMYK color mode in the processing in Act 3 to Act 6. However, if the colors of ink used by the liquid discharge sections 2 of the inkjet recording apparatus are not CMYK, the inkjet recording apparatus 1 converts the image data in RGB color mode to the image data corresponding to the color of the ink.

Further, the liquid discharge section 2 can also discharge transparent glossy ink, ink that develops color if irradiated with infrared rays or ultraviolet rays, or other special ink. Furthermore, the liquid discharge section 2 may be capable of discharging the liquid other than the ink. The liquid discharged by the liquid discharge section 2 may be dispersion liquid such as a suspension. As the liquid other than the ink discharged by the liquid discharge section 2, for example, liquid containing conductive particles for forming the wiring pattern of the print wiring board, liquid including a cell for artificially forming a tissue or an organ, binder such as adhesive, wax, or liquid resin are exemplified.

While certain embodiments of the present invention have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A liquid discharge head, comprising:
a droplet frequency controller configured to control a number of times droplets are discharged for one pixel based on input image data; and
a discharge amount controller configured to control a discharge amount of the droplet based on the input image data.

2. The liquid discharge head according to claim 1, further comprising:
a separation section configured to separate the input image data into first data to be input to the droplet frequency controller and second data to be input to the discharge amount controller.

3. The liquid discharge head according to claim 2, wherein
the first data is a bit string representing a gradation, and
the second data is a bit string obtained by dividing the gradation into finer gradations.

4. The liquid discharge head according to claim 1, further comprising:
a discharge section configured to discharge droplets based on control by the droplet frequency controller and the discharge amount controller.

5. The liquid discharge head according to claim 1, further comprising:
a color controller configured to determine an ink color based on the input image data.

6. The liquid discharge head according to claim 5, wherein ink color is selected from cyan, magenta, yellow, or black.

7. The liquid discharge head according to claim 1, wherein the input image data comprises gradation data.

8. A liquid discharge apparatus comprising a liquid discharge head, the liquid discharge head comprises:
a droplet frequency controller configured to control the number of times droplets are discharged for one pixel based on input image data; and
a discharge amount controller configured to control a discharge amount of the droplet based on the input image data.

9. The liquid discharge apparatus according to claim 8, further comprising:
a separation section configured to separate the input image data into first data to be input to the droplet frequency controller and second data to be input to the discharge amount controller.

10. The liquid discharge apparatus according to claim 9, wherein
the first data is a bit string representing a gradation, and
the second data is a bit string obtained by dividing the gradation into finer gradations.

11. The liquid discharge apparatus according to claim 8, further comprising:
a discharge section configured to discharge droplets based on control by the droplet frequency controller and the discharge amount controller.

12. The liquid discharge apparatus according to claim 8, further comprising:
a color controller configured to determine an ink color based on the input image data.

13. The liquid discharge apparatus according to claim 12, wherein ink color is selected from cyan, magenta, yellow, or black.

14. The liquid discharge apparatus according to claim 8, wherein the input image data comprises gradation data.

15. The liquid discharge apparatus according to claim 8, wherein the liquid discharge apparatus is an inkjet printer.

16. A liquid discharge method in a printer, comprising:
controlling a number of times droplets are discharged for one pixel based on input image data; and
controlling a discharge amount of the droplet based on the input image data.

17. The liquid discharge method according to claim 16, further comprising:
separating the input image data into first data to be input for controlling the number of times droplets are discharged and second data to be input to for controlling the discharge amount.

18. The liquid discharge method according to claim 17, wherein
the first data is a bit string representing a gradation, and
the second data is a bit string obtained by dividing the gradation into finer gradations.

19. The liquid discharge method according to claim 16, further comprising:
discharging droplets based on controlling a number of times droplets are discharged and controlling a discharge amount of the droplet.

20. The liquid discharge method according to claim 16, further comprising:
determining an ink color for droplets based on the input image data.
